(19) United States
(12) Patent Application Publication
(10) Pub. No.: US 2008/0093388 A1
(43) Pub. Date: Apr. 24, 2008

(54) ATTACHMENT FOR REPETITIVE SYRINGE DISPENSER

(76) Inventor: Justin K. Markunas, Washington, DC (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(21) Appl. No.: 11/427,147

(22) Filed: Jun. 28, 2006

(51) Int. Cl. G01F 11/00

(52) U.S. Cl. 222/319

(57) ABSTRACT

An attachment provides automatic control to a repetitive syringe drip dispenser. The dispenser has a push button which when pushed causes a shaft inside the body of the dispenser to travel a precisely-controlled distance thereby pushing the piston of a syringe and dispensing a controlled amount of liquid. The attachment includes a push-type solenoid disposed within the body of the attachment and having a plunger adapted to lie directly over the push button. The attachment further includes a logic circuit comprising timer, counter, and relay integrated circuits connected to the solenoid for feeding power to the solenoid from an external power source, a plurality of push buttons connected to the logic circuit for setting the rate and number of times the push button of the dispenser is to be pushed by the solenoid, and a plurality of light emitting diodes connected to the logic circuit for displaying the set values.

### GOVERNMENT INTEREST

The invention described herein may be manufactured, used, sold, imported, and/or licensed by or for the Government of the United States of America.

### FIELD OF THE INVENTION

The present invention generally relates to measuring and testing, and more particularly, to repetitive pipettes.

### BACKGROUND OF THE INVENTION

Many fields of scientific research require precisely controlled dispensation of a liquid. In the genetics field, the control over chemical volumes required to make copies of DNA by the polymerase chain reaction (PCR) technique can be as little as a micro-liter. In the fabrication of electronic sensors, precise amounts of chemicals are dripped onto a spinning silicon wafer to etch away the surface oxide and passivate the remaining surface. This process allows for the optimal growth of cadmium telluride on the silicon wafer by molecular beam epitaxy.

With reference to FIG. 1, the precision required for these applications can be achieved with a simple repetitive syringe drip dispenser 10, such as the Nichiryo model 8100 variable volume repetitive syringe dispenser described in U.S. Pat. No. 5,747,709, the disclosure of which is hereby incorporated by reference. When a user pushes a push button 11 on the right side, a shaft (not shown) inside the body of the device travels a precisely controlled distance. This shaft pushes a plunger 13 (or piston) of a syringe 15 and dispenses a controlled amount of liquid, e.g., a chemical. The amount of chemical dispensed can range from 1 micro-liter to the tens of milliliters, based on the size of the syringe used. The typical cost of such a device is a few hundred dollars.

While the repetitive syringe drip dispenser 10 is capable of the high-precision dispensation of chemicals required in many fields of research, it does have a major shortcoming: manual rate control. In the previously mentioned infrared sensor application, one may wish to drip a volume of a chemical onto a silicon wafer (not shown) ten times in rapid succession. While the user can be confident in the amount of volume dispensed, there is little control over the period of time between each successive drip because the pushing of the push button 11 is under the user's control. If this period of time is too long, the surface of the wafer will spin dry before the next drip. This is undesirable. If the period of time is too short, an excess of chemicals will be incident upon the wafer. This is also undesirable since the excess chemicals will be spun off before they have a chance to react with the surface of the wafer. This is just one example of a myriad of chemical processes where the rate of chemical dispensation may be critical to the success of the process.

There currently is an alternative to the repetitive syringe drip dispenser 10 and one example, the Gilson model 402 automated diluter dispenser 16 is shown in FIG. 2.

The basic operation of the automated diluter dispenser 16 is similar to that of the manual repetitive syringe drip dispenser 10. The contents of a syringe 17 are forced out by the precisely controlled upward motion of a piston 19, and are then dispensed by a probe 21. Like the manual repetitive syringe drip dispenser 10, the volume of chemical dispensed can range from 1 micro-liter to tens of milliliters. The important difference between the automated diluter dispenser 16 and the manual repetitive syringe drip dispenser is a control unit 23. The control unit 23 allows for control over a variety of factors, including the rate at which a liquid is dispensed.

While it appears the problem of controlling the rate of chemical dispensation has been solved, there are some drawbacks to the automated diluter dispenser 16 illustrated in FIG. 2. First of all, automated diluter dispensers cost a few thousand dollars versus a couple hundred for manual dispensers. Additionally, many experimental processes involve more than one chemical, thus multiplying the number of automated diluter dispensers required (While it is entirely possible to use different chemicals in the automated diluter dispensers, it would be impossible to do so in rapid succession). In the end, one could spend many thousands of dollars for a set of automated diluter dispensers for just one chemical process.

### SUMMARY OF THE INVENTION

There is a need for a simple and reliable device to bridge the gap between low-cost manual dispensers with no rate control and high-cost automated dispensers. The present invention provides an attachment for automating a repetitive syringe drip dispenser, wherein the dispenser has a push button which when pushed causes a shaft inside the body of the dispenser to travel a precisely-controlled distance thereby pushing the piston of a syringe and dispensing a controlled amount of liquid. The attachment comprises means adapted to be connected to the dispenser for automatically pushing the push button of the dispenser at a desired rate for a desired number of times to dispense successive drips from the dispenser and means connected to the pushing means for setting the rate and number of times the push button of the dispenser is to be pushed.

Another aspect of the invention relates to a method for automating a repetitive syringe drip dispenser. The dispenser has a push button which when pushed causes a shaft inside the body of the dispenser to travel a precisely-controlled distance thereby pushing the piston of a syringe and dispensing a controlled amount of liquid. The method comprises the steps of attaching an attachment to the dispenser for automatically pushing the push button of the dispenser at a desired rate for a desired number of times to dispense successive drips from the dispenser and setting the rate and number of times the push button is to be pushed.

The attachment retrofits to a manual dispenser, and provides control over the rate and total volume of chemical dispensed.

While it is unlikely that this invention would find usage in large industries such as silicon semiconductors, there would be great potential for this invention to be used in many smaller research and development labs and universities, where a variety of fields require controlled dispensation of chemicals. The first reason is that many of these facilities have relatively small budgets and will be unwilling to spend thousands on automated dispensers to control chemical processes. Additionally, this invention is a retrofit to manual dispensers. Since many labs already own sets of manual dispensers, the cost to upgrade to an automated dispenser will only be the cost of the retrofit. This cost will be far less than a fully automated dispenser, such as the Gilson 402. Finally, most small research and development labs and university labs have many users working on a multitude of processes. In order to perform each of these in a time-effective manner, many automated dispensation systems would be required to dispense all of the different chemicals. Instead, retrofitting manual dispensers could do the job at a fraction of the cost.

To the accomplishment of the foregoing and related ends, the invention provides the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 is a schematic perspective view of a Nichiryo model 8100 variable volume repetitive syringe dispenser;

FIG. 2 is a schematic perspective view of a Gilson model 402 automated diluter dispenser;

FIG. 3 is a side sectional view of an embodiment of the attachment for automating a repetitive syringe drip dispenser;

FIG. 4 is a cross-sectional view of a controls and display unit in accordance with the invention;

FIG. 5 is a cross-sectional view of a circuit board in accordance with the invention;

FIG. 6 is a cross-sectional view of a solenoid in accordance with the invention;

FIG. 7 is a cross-sectional view of a collar in accordance with the invention;

FIG. 8 is a side sectional view of an embodiment of the attachment with a repetitive syringe drip dispenser in accordance with the invention.

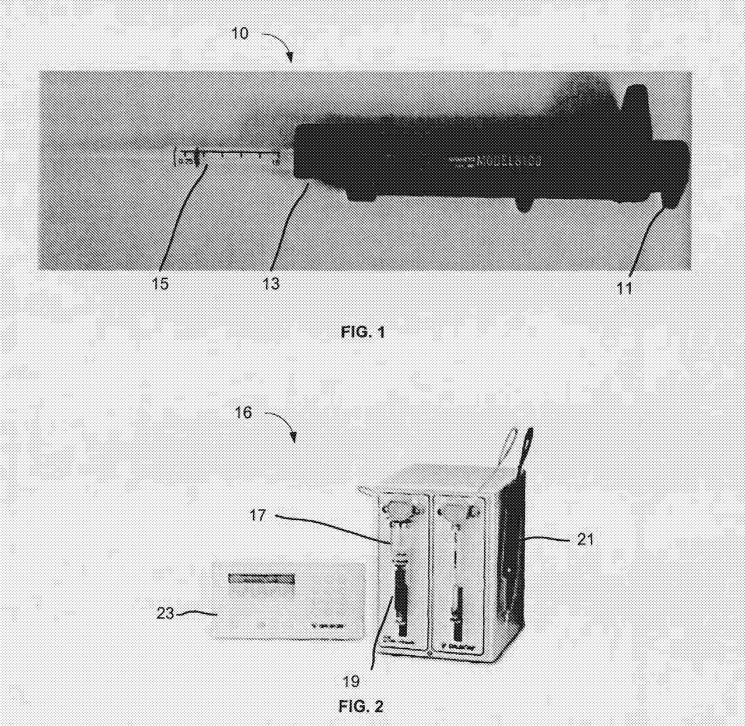

In the detailed description that follows, identical components have been given the same reference numerals.

### DETAILED DESCRIPTION

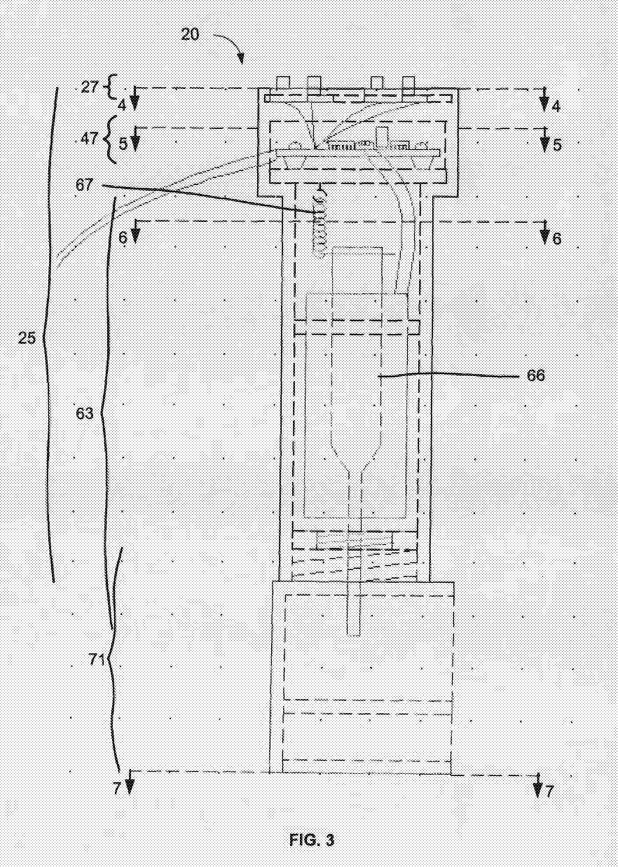

Referring now to the FIG. 3, the present invention provides an attachment 20 for automating a repetitive syringe drip dispenser 10. The attachment 20 includes five main parts. The exact dimensions are not included since they are non-critical to the performance of the attachment 20.

The body 25 consists of two injection-molded plastic halves that are glued together. The purpose of the body 25 is to hold the rest of the attachment 20 in place.

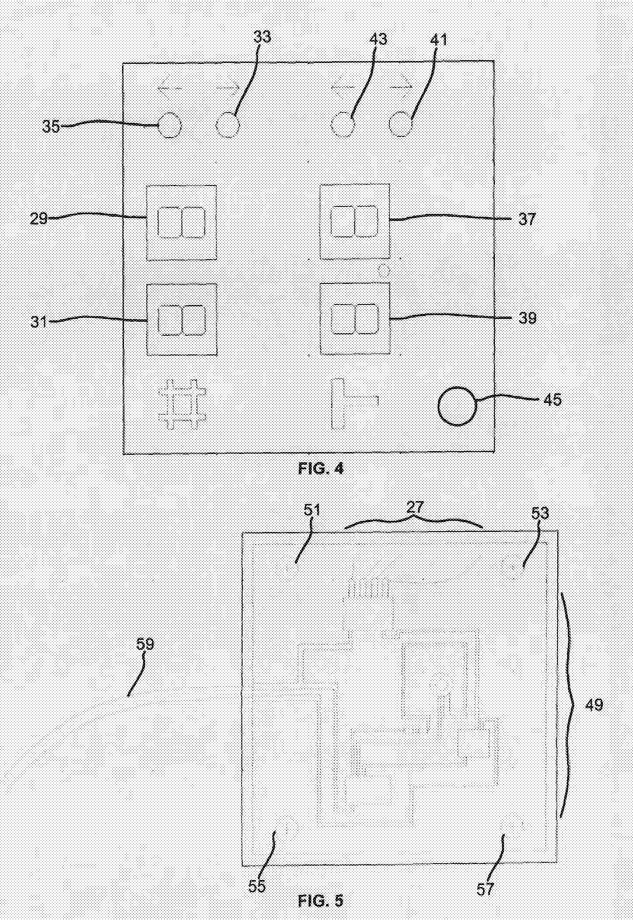

The controls and display unit 27 is the user interface of the attachment 20. A cross section is shown in FIG. 4. Individual parts may be glued directly to the body 25 or placed on a printed circuit board and fastened to the body. FIG. 4 shows the parts glued onto the body. Two eight segment light emitting diodes 29 and 31 display the number of drips to be dispensed. A push button 33 increases the number of drips to be dispensed, while another push button 35 decreases the number. Changes made to the number of drips will be displayed by the light emitting diodes. Another set of two eight segment light emitting diodes 37 and 39 display the period of time between each drip, to a precision of tenths of a second. A push button 41 increases the amount of time between drips while another push button 43 decreases the time. Changes made to the time between drips will be displayed by the corresponding light emitting diodes 37 and 39. Once the user has defined the dripping parameters, a start button 45 is pushed to begin the dispensation process.

Referring once again to FIG. 3A, a circuit board 47 is illustrated, i.e., the brain behind the system. The circuit board 47 provides the logic required for the correct dispensation scheme and routes electricity for each component of the device to operate. A cross-section is shown in FIG. 5. The reference numeral 49 denotes a variety of timer, counter, and-relay integrated circuits on a printed circuit board. No specific circuit schematics are given since the construction of a suitable logic circuit is deemed to be within the skill of one of ordinary skill in the art. The circuit board 47 is fastened into the body 25 in four places with standoffs 51, 53, 55, and 57, creating space between the circuit board and the body for wiring to be routed. A wire 59 is connected to an external AC adapter (not shown), such as a 12V adapter, needed to power the entire system. A set of wires 61 from the circuit board is provided to send control signals to the controls and display unit 27.

The solenoid, labeled 63 in FIG. 3, provides the mechanical motion to physically push the push button 11 (FIG. 1) of the repetitive syringe drip dispenser, thus dispensing the fluid. A cross-section view of the solenoid 63 is shown in FIG. 6. The solenoid is a push-type and should be capable of pushing with a force of at least 25 ounces over at least ¼ of an inch. A spring 65 returns a plunger 66 of the solenoid to its initial state. The spring 65 is connected to the plunger of the solenoid and a hook 67 that is fastened to the body 25. Reference numeral 69 denotes the wiring needed to power the solenoid 63. These wires 69 are connected to components on the circuit board 47.

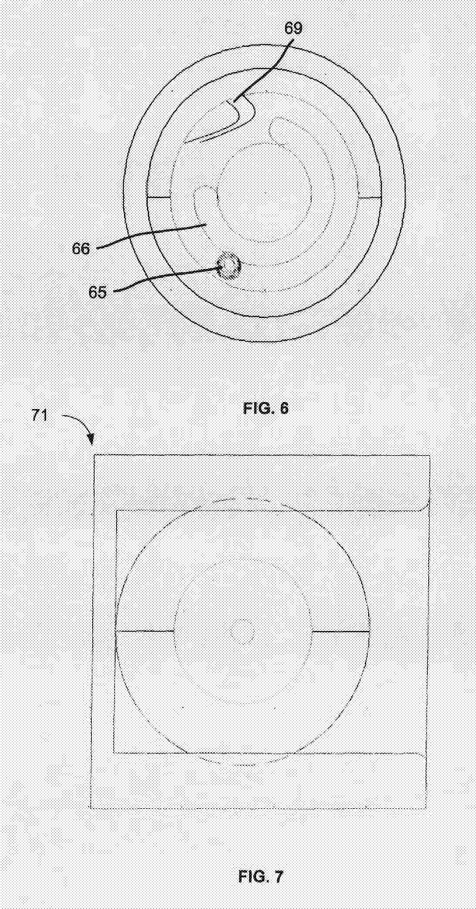

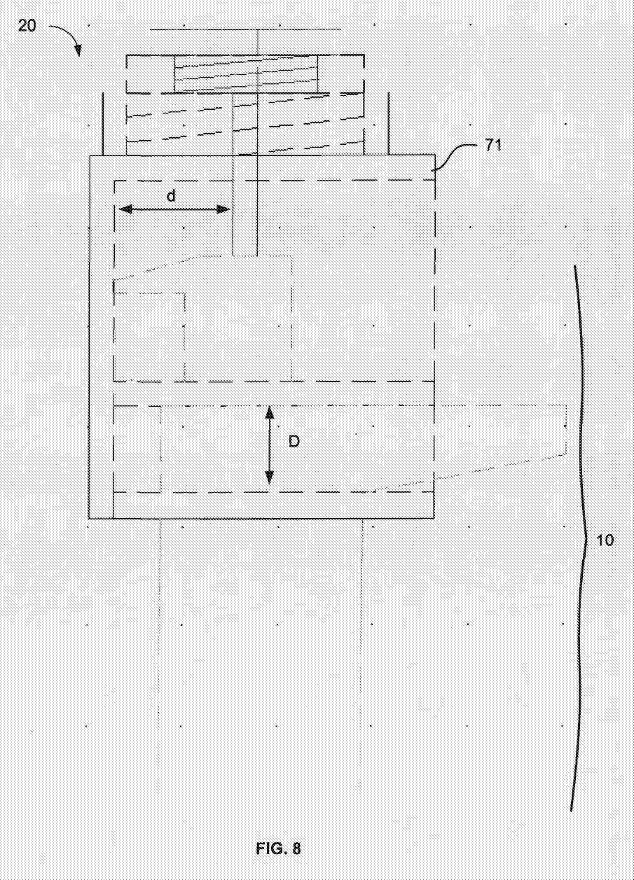

A collar, labeled 71 in FIG. 3, is the interface between the attachment 20 and the repetitive syringe drip dispenser 10. A cross-section of the collar 71 is shown in FIG. 7. The collar 71 screws directly into the body 25 and the repetitive syringe drip dispenser 10 is placed into attachment 20, as shown in FIG. 8. Dimensions of the collar will thus vary based on the specific repetitive syringe drip dispenser to be used. That is, different sized collars could be produced to fit dispensers of different sizes made by different companies). The collar 71 should provide a snug fit to the repetitive syringe drip dispenser, therefore the parameter D in FIG. 8 should be chosen correctly. Also, the push button 11 of the repetitive syringe drip dispenser needs to lie directly under the plunger 66 of the solenoid 63, therefore the parameter d in FIG. 8 must be chosen correctly. The collar 71 is thus an interchangeable part and can be made to fit any repetitive syringe dispenser.

Next, the operation of this attachment will be described. The AC adapter is first plugged in, providing power to the attachment 20. The user then adjusts the number of drips and time between drips to be dispensed by pushing the appropriate buttons on the controls and display unit 27. These values will be shown on the eight segment light emitting diodes 29, 31, 37 and 39. After the user makes the desired adjustments, the repetitive syringe drip dispenser 10 is then placed into the collar 71. The user then presses the start button 45 on the controls and display unit 27. Based on the user inputs, the circuit board 47 controls the power to the solenoid 63, which mechanically pushes the push button 11 of the repetitive syringe drip dispenser for the correct number of drips and interval between consecutive drips. Once the liquid has been dispensed, the attachment 20 can be shut down and the repetitive syringe drip dispenser may be removed. If the user has different models of repetitive syringe drip dispensers, the collars 71 can easily be changed to provide the correct interface to the attachment 20.

Although the invention has been shown and described with respect to certain preferred embodiments, it is obvious that equivalent alterations and modifications will occur to others skilled in the art upon the reading and understanding of this specification and the annexed drawings. In particular regard to the various functions performed by the above described components (assemblies, devices, sensors, circuits, etc), the terms (including a reference to a “means”) used to describe such components are intended to correspond, unless otherwise indicated, to any component which performs the specified function of the described component (i.e., functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application.

What is claimed is:

1. An attachment for automating a repetitive syringe drip dispenser, the dispenser having a push button which when pushed causes a shaft inside the body of the dispenser to travel a precisely-controlled distance thereby pushing the piston of a syringe and dispensing a controlled amount of liquid, the attachment comprising:
means adapted to be connected to the dispenser for automatically pushing the push button of the dispenser at a desired rate for a desired number of times to dispense successive drips from the dispenser; and
means connected to the automatically pushing means for setting the rate and number of times the push button of the dispenser is to be pushed.

2. The attachment recited in claim 1 wherein the automatically pushing means includes:
a push-type solenoid disposed within the body of the attachment.

3. The attachment recited in claim 2 wherein the solenoid has a plunger adapted to lie directly over the push button of the dispenser.

4. The attachment recited in claim 3 wherein the solenoid is capable of pushing with a force of at least 25 ounces over at least ¼ of an inch.

5. The attachment recited in claim 3 wherein the pushing means includes:
a hook fastened into the body of the attachment.

6. The attachment recited in claim 5 wherein the pushing means includes:
a spring connecting the plunger to the hook for returning the plunger to its initial state after the button of the dispenser is pushed.

7. The attachment recited in claim 2 wherein the setting means includes:
a logic circuit disposed within the body of the attachment and comprised of timer, counter, and relay integrated circuits connected to the solenoid for feeding power to the solenoid from an external power source.

8. The attachment recited in claim 7 wherein the setting means includes:
a push button connected to the logic circuit for setting the rate at which the push button of the dispenser is to be pushed by the solenoid.

9. The attachment recited in claim 7 wherein the setting means includes:
a push button connected to the logic circuit for setting the number of times the push button of the dispenser is to be pushed by the solenoid.

10. The attachment recited in claim 8 wherein the setting means includes:
a plurality of light emitting diodes connected to the logic circuit for displaying the set value.

11. The attachment recited in claim 9 wherein the setting means includes:
a plurality of light emitting diodes connected to the logic circuit for displaying the set value.

12. The attachment recited in claim 1 in combination with the repetitive syringe drip dispenser.

13. The attachment recited in claim 3 wherein the setting means includes:
a logic circuit disposed within the body of the attachment and comprised of timer, counter, and relay integrated circuits connected to the solenoid for feeding power to the solenoid from an external power source.

14. The attachment recited in claim 13 wherein the setting means includes:
a push button connected to the logic circuit for setting the rate at which the push button of the dispenser is to be pushed by the solenoid.

15. The attachment recited in claim 14 wherein the setting means includes:
a push button connected to the logic circuit for setting the number of times the push button of the dispenser is to be pushed by the solenoid.

16. The attachment recited in claim 15 wherein the setting means includes:
a plurality of light emitting diodes connected to the logic circuit for displaying the set value.

17. The attachment recited in claim 16 wherein the setting means includes:
a plurality of light emitting diodes connected to the logic circuit for displaying the set value.

18. An attachment for automating a repetitive syringe drip dispenser, the dispenser having a push button which when pushed causes a shaft inside the body of the dispenser to travel a precisely-controlled distance thereby pushing the piston of a syringe and dispensing a controlled amount of liquid, the attachment comprising:
a push-type solenoid disposed within the body of the attachment and having a plunger adapted to lie directly over the push button, the solenoid capable of pushing with a force of at least 25 ounces over at least ¼ of an inch;
a hook fastened into the body of the attachment;
a spring connecting the plunger to the hook for returning the plunger to its initial state after the button of the dispenser is pushed;
a logic circuit disposed within the body of the attachment and comprised of timer, counter, and relay integrated circuits connected to the solenoid for feeding power to the solenoid from an external power source;
a plurality of push buttons connected to the logic circuit for setting the rate and number of times the push button of the dispenser is to be pushed by the solenoid; and
a plurality of light emitting diodes connected to the logic circuit for displaying the set values.

19. The attachment recited in claim 18 in combination with the repetitive syringe drip dispenser.

20. A method for automating a repetitive syringe drip dispenser, the dispenser having a push button which when pushed causes a shaft inside the body of the dispenser to travel a precisely-controlled distance thereby pushing the piston of a syringe and dispensing a controlled amount of liquid, the method comprising the steps of:
attaching an attachment to the dispenser for automatically pushing the push button of the dispenser at a desired rate for a desired number of times to dispense successive drips from the dispenser; and
setting the rate and number of times the push button is to be pushed.
